(19) United States
(12) Patent Application Publication
(10) Pub. No.: US 2025/0248456 A1
(43) Pub. Date: Aug. 7, 2025

(54) Method of an Aerosol Generation Device, Method of an Aerosol Generation Device Case, Aerosol Generation Device and Aerosol Generation Device Case

(71) Applicant: JT International SA, Geneva (CH)

(72) Inventors: Layth Sliman Bouchuiguir, Bellevue (CH); Pier Paolo Monticone, Le Grand-Saconnex (CH)

(73) Assignee: JT International SA, Geneva (CH)

(21) Appl. No.: 18/852,691

(22) PCT Filed: Mar. 28, 2023
(86) PCT No.: PCT/EP2023/057953

§ 371 Date: Sep. 30, 2024

(30) Foreign Application Priority Data
Mar. 30, 2022 (EP) 22165446.0

(51) Int. Cl. A24F 40/65; A24F 15/01; A24F 40/53; A24F 40/60; H04W 4/80

(52) U.S. Cl. CPC A24F 40/65; A24F 15/01; A24F 40/53; A24F 40/60; H04W 4/80

(57) ABSTRACT

A method of an aerosol generation device includes—determining whether the aerosol generation device is connected to an aerosol generation device case for a first time; —and in a case where the aerosol generation device is connected to the aerosol generation device case for a first time, pairing with the aerosol generation device case by: transmitting, to the aerosol generation device case, an identifier of the aerosol generation device; receiving, from the aerosol generation device case, an identifier of the aerosol generation device case; storing the received identifier in a memory section of the aerosol generation device; and establishing a wireless communication link with the paired aerosol generation device case.

### TECHNICAL FIELD

The present invention generally relates to the field of aerosol generation devices. In particular, the present invention is directed to an aerosol generation device, an aerosol generation device case, a system comprising an aerosol generation device and an aerosol generation device case, methods for an aerosol generation device, and methods for an aerosol generation device case.

### BACKGROUND

Aerosol generation devices, also referred to as inhalation devices, such as e-cigarettes, vaping devices and aerosol inhalers, are known.

Such aerosol generation devices conventionally include an atomizer, a power supply and a tobacco stick, liquid-filled capsule, or similar means disposed therein in order to generate an aerosol (that is, a vapour) that may be inhaled by the user. Such means may be referred to as an aerosol-generating article and may contain an amount of an aerosol-generating material.

The generated aerosol may contain, for example, a form of nicotine such that user of the inhalation device may, for example, simulate smoking tobacco by inhaling the generated aerosol.

Such aerosol generation devices are generally hand-held devices. In general, handheld aerosol generation devices have to be of a relatively small size and relatively low weight in order to be handheld. This can often result in aerosol generation devices having limited memory space and/or power supply, and/or a simple or minimal user interface.

### SUMMARY OF THE INVENTION

### Technical Problem

Aerosol generation devices may be provided with a compatible aerosol generation device case. Such aerosol generation device cases are generally in the form of a handheld electronic device.

An aerosol generation device case may be designed to receive all or part of an aerosol generation device therein when the aerosol generation device is not in use and to provide one or more functions. By way of example, an aerosol generation device case may have a function of charging an aerosol generation device received therein.

However, aerosol generation device cases may have alternative or additional functions such as, for example, storing and protecting the aerosol generation device when not in use (e.g. during transport), providing a user interface via which the user may use to configure the aerosol generation device received therein, and/or providing terminals via which external entities (e.g. smart phones, laptops, etc.) may interact with the aerosol generation device received therein.

However, the present inventors have recognised that various problems may arise in the use of an aerosol generation device having an aerosol generation device case.

By way of example, a user may realize during or after using the aerosol generation device that they have forgotten where they left the aerosol generation device case and be unable to find it or realise that they have left their aerosol generation device case at a previous location. Similarly, the user may lose, misplace or leave behind the aerosol generation device, for example, if the user does not return the aerosol generation device to the aerosol generation device case immediately after use.

Furthermore, existing aerosol generation devices and aerosol generation device cases generally have standard designs and appearance, particularly, for products within a same range or from a same vendor. As such, many users may have aerosol generation devices and aerosol generation device cases with similar or identical appearances.

Therefore, a problem may arise where a user mistakes someone else's aerosol generation device or aerosol generation device case for their own.

### Summary of the Solution

The present invention is intended to address one or more of the above technical problems.

In particular, in view of the limitations discussed above, the present inventors have devised, in accordance with a first example aspect herein, a method of an aerosol generation device comprising determining whether the aerosol generation device is connected to an aerosol generation device case for a first time. The method further comprises, in a case where the aerosol generation device is connected to the aerosol generation device case for a first time, pairing with the generation aerosol device case by: transmitting, to the aerosol generation device case, an identifier of the aerosol generation device; receiving, from the aerosol generation device case, an identifier of the aerosol generation device case; and storing the received identifier in a memory section of the aerosol generation device. The method further comprises establishing a wireless communication link with the paired aerosol generation device case.

The present inventors have further devised, in accordance with a second example aspect herein, a method of an aerosol generation device case comprising determining whether the aerosol generation device case is connected to an aerosol generation device for a first time. The method further comprises, in a case where the aerosol generation device case is connected to the aerosol generation device for a first time, pairing with the aerosol generation device by: transmitting, to the aerosol generation device, an identifier of the aerosol generation device case; receiving, from the aerosol generation device, an identifier of the aerosol generation device; and storing the received identifier in a memory section of the aerosol generation device case. The method further comprises establishing a wireless communication link with the paired aerosol generation device.

The present inventors have further devised, in accordance with a third example aspect herein, an aerosol generation device comprising a transmitting/receiving section, a memory section, and a control section. The control section is configured to control the transmitting/receiving section and the memory section perform the method according to the first example aspect herein.

The present inventors have further devised, in accordance with a fourth example aspect herein, an aerosol generation device case comprising a transmitting/receiving section; a memory section, and a control section.

The control section is configured to control the transmitting/receiving section and the memory section to perform a method according to the second aspect.

The present inventors have further devised, in accordance with a fifth example aspect herein, a computer program which, when the program is executed by a control section of an aerosol generation device, cause the control section to perform the method according to the first example aspect herein.

The present inventors have further devised, in accordance with a sixth example aspect herein, a computer program which, when the program is executed by a control section of an aerosol generation device case, cause the control section to perform the method according to the second example aspect herein.

The present inventors have further devised, in accordance with a seventh example aspect herein, a system comprising an aerosol generation device according to the third example aspect and an aerosol generation device case according to the fourth example aspect.

### BRIEF DESCRIPTION OF THE DRAWINGS

Embodiments of the invention will now be explained in detail, by way of non-limiting example only, with reference to the accompanying figures, described below. Like reference numerals appearing in different ones of the figures can denote identical or functionally similar elements, unless indicated otherwise.

FIG. 1 is a schematic illustration of an aerosol generation device, according to an example aspect herein.

FIG. 2 is a block diagram illustrating components of an aerosol generation device, in accordance with an example aspect herein.

FIG. 3 is a schematic illustration of a system comprising the aerosol generation device of FIG. 1 and an aerosol generation device case, according to an example aspect herein.

FIG. 4 is a block diagram illustrating components of a case, in accordance with an example aspect herein.

Accordingly, FIG. 5 is a flow diagram illustrating a process by which the aerosol generation device of FIG. 1 may establish a wireless communication link with a paired aerosol generation device case, in accordance with an example aspect herein.

FIG. 6 is a flow diagram showing an exemplary process by which a control section of an aerosol generation device may determine whether the aerosol generation device is connected to a case for a first time.

FIG. 7 is a flow diagram illustrating a first process performed by the aerosol generation device of FIG. 1 that has established a wireless communication link with the case of FIG. 3.

FIG. 8 is a flow diagram illustrating a second process performed by the aerosol generation device of FIG. 1 that has established a wireless communication link with the case of FIG. 3.

FIG. 9 is a flow diagram illustrating a process by which the control section of an aerosol generation device may output the alert via the output section of the aerosol generation device in response to received user input.

FIG. 10 is a flow diagram illustrating a third process performed by the aerosol generation device of FIG. 1 that has established a wireless communication link with the case of FIG. 3.

FIG. 11 is a flow diagram illustrating a fourth process performed by the aerosol generation device of FIG. 1.

FIG. 12 is a flow diagram illustrating a process by which the case of FIG. 3 may establish a wireless communication link with a paired aerosol generation device, in accordance with an example aspect herein.

FIG. 13 is a flow diagram illustrating an exemplary process by which a control section of a case may determine whether the case is connected to an aerosol generation device for a first time.

FIG. 14 is a flow diagram illustrating a first process performed by the case of FIG. 3 that has established a wireless communication link with the aerosol generation device of FIG. 1.

FIG. 15 is a flow diagram illustrating a second process performed by the case of FIG. 3 that has established a wireless communication link with the aerosol generation device of FIG. 1.

FIG. 16 is a flow diagram illustrating an exemplary process by which the control section of the case may output the alert via an output section of the case in response to received user input.

FIG. 17 is a flow diagram illustrating a third process performed by the case of FIG. 3 that has established a wireless communication link with the aerosol generation device of FIG. 1.

FIG. 18 is a flow diagram illustrating a fourth process performed by the case of FIG. 3.

### DETAILED DESCRIPTION

Example embodiments of the present invention will now be described in detail with reference to the accompanying drawings.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

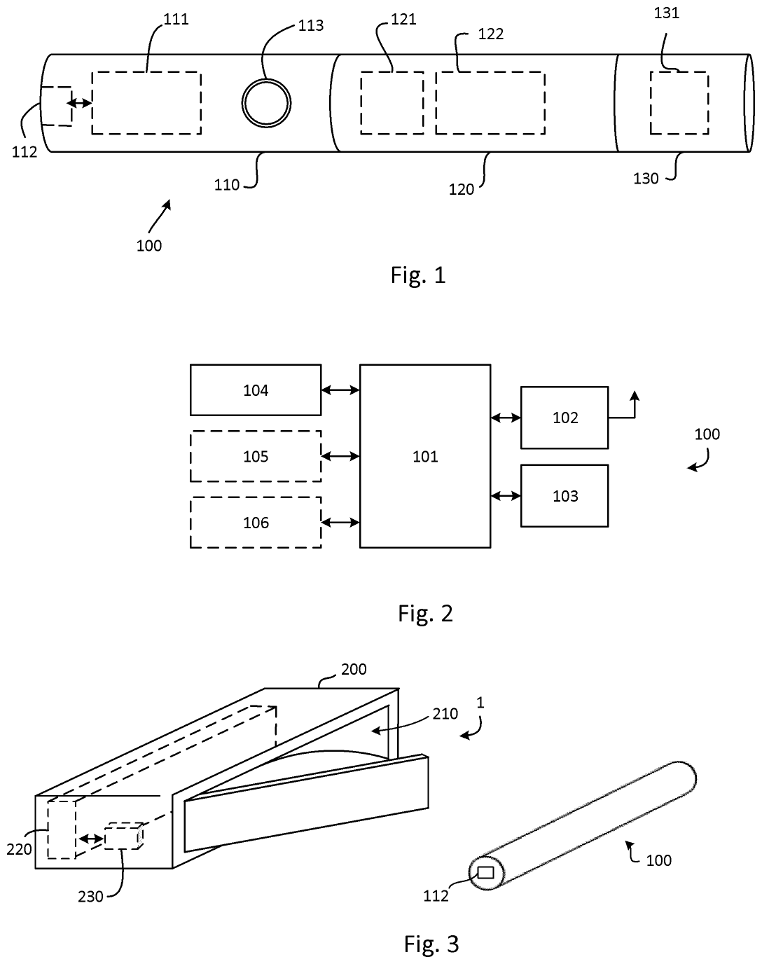

FIG. 1 is a schematic illustration of an aerosol generation device 100, according to an example aspect herein.

The aerosol generation device 100 is a handheld device that is configured to generate an aerosol (that is, a vapour) that may be inhaled by a user of the aerosol generation device 100. The aerosol generation device 100 comprises a power supply unit 110, an aerosol generation unit 120 and a mouthpiece 130.

The power supply unit 110 may, as in the present example embodiment, comprise a power supply 111, a terminal 112 and an input means 113. By way of example, the input means 113 may, as in the present example embodiment, comprise a button.

The power supply 111 may, as in the present example embodiment, be a rechargeable power supply. The power supply 111 may, as in the present example embodiment, be a lithium ion battery. Alternatively, the power supply 111 may be, for example, a chargeable secondary battery or an electric double layer capacitor (EDLC).

The terminal 112 may, as in the present example embodiment, comprise a power terminal for use in charging the power supply 111. That is, the terminal 112 may, as in the present example embodiment, be connectable to an external device, such as the aerosol generation device case 200 described in relation to FIG. 3, or the mains power supply and be configured to receive power to charge the power supply 111.

Additionally or alternatively, the terminal 112 may, as in the present example embodiment, comprise a data terminal to enable transmission of data to and reception of data from an external device connected to the aerosol generation device 100 via the terminal 112.

By way of example, the terminal 112 may include one or more of a USB terminal, a micro USB terminal, a wireless charging terminal, etc.

The aerosol generation unit 20 may, as in the present example, an aerosol-generating article 122 containing an amount of an aerosol-generating material and a load 121 for atomizing the aerosol-generating material in the aerosol-generating article 122. Power is provided to the load 121 by the power supply unit 110.

By way of example, the aerosol-generating article 122 may comprise a reservoir or a capsule for storing an aerosol-generating material in liquid form. Alternatively, the aerosol-generating material may comprise a tobacco stick (also referred to as a “heatable tobacco stick”, “a heated-tobacco stick”, etc.), a gel-like composition in a capsule or pod, or similar means, depending on the type of

The load 121 atomizes the aerosol-generating material (for example, by heating) thereby generating an aerosol which passes through the mouthpiece 30 in response to the inhalation action of the user. In one example, the load 121 is represented by the electrical load of a heating element, i.e. the energy consumed by the heating element. The heating element may be resistive, inductive, etc.

By way of example, the aerosol generation device 100 may, as in the present example embodiment, be a so-called “e-vapour” device. Alternatively, the aerosol generation device may be a so-called “T-vapor” device, also commonly referred to as a Heat-not-Burn device or a heated tobacco device.

The mouthpiece 130 may, as shown in FIG. 1, comprise a flavour source 131. The flavour source 131 may, for example, contain grains of shredded raw tobacco or another plant (e.g. mint or herbs) and/or flavours such as menthol such that, a flavour is added to the aerosol as it passes through the flavour source 131. Furthermore, the mouthpiece 130 may contain any suitable inhalation ports, etc. (not shown) required for the user to inhale the generated aerosol.

The power supply unit 110, the aerosol generation unit 120 and the mouthpiece 130 may be detachable such that individual units may be readily replaced. Additionally or alternatively, aerosol-generating article 122 and/or the aerosol-generating material stored therein and flavour source 131 may be detachable from their respective units and replaceable.

While the aerosol generating unit 120 and the mouthpiece 130 of the aerosol generation device 100 of FIG. 1 are shown as separate units, these two units may alternatively be provided as a single unit and flavour source 131 may optionally be provided with the aerosol-generating material in the aerosol-generating article 121.

FIG. 2 is a block diagram illustrating components of an aerosol generation device 100, in accordance with an example aspect herein.

As shown in FIG. 2, the aerosol generation device 100 includes a control section 101, transmission/reception (Tx/Rx) section 102, and a memory section 103. Additionally, the aerosol generation device 100 may, as in the present example embodiment, comprise an output section 104 and, optionally, an input section 105 and/or at least one sensor 106.

The control section 101 may comprise one or more processing units (e.g. a central processing unit (CPU) such as a microprocessor, or a suitably programmed field programmable gate array (FPGA) or application-specific integrated circuit (ASIC)).

The control section 101 may, as in the present example, be configured to control operation of the aerosol generation device 100. The control section 101 may, as in the present example embodiment, include separate modules or sections for each function performed.

By way of example, the control section 101 may control supply of power to the aerosol generation unit 120 and charging of the power supply 111. Additionally or alternatively, the control section 101 may control supply of power to the at least one sensor 106 as necessary, receive and process signals from the at least one sensor 106, and control operation of the aerosol generation device 100 based on the received signals. Additionally or alternatively, the control section 101 may control output of information to a user of the aerosol generation device 100 via the output section 104, reception of user input by the input section 105 and control operation of the aerosol generation device 100 based on the received user input.

The Tx/Rx section 102 may be configured to transmit and receive information by any suitable wireless communication means known to those versed in the art. For example, the Tx/Rx section 102 may transmit or receive information via a direct communication link provided by any suitable wireless connection, e.g. a Bluetooth™, NFC, or NR connection, or an indirect communication link (which may be provided by a network comprising a Local Area Network (LAN), a Wide Area Network (WAN) and/or the Internet). Furthermore, Tx/Rx section 102 may comprise processing and communication functionalities necessary to operate in accordance with one or more conventional telecommunication standards, including—but not limited to—GSM, PCS, 3GPP, LTE, LTE-A, UMTS, 3G, 4G, 5G.

Additionally, the Tx/Rx section may, 102 as in the present example embodiment, be configured to transmit and receive information by any suitable wired communication means known to those versed in the art, e.g. a Universal Serial Bus (USB) connection. In such example embodiments, the Tx/Rx section 102 may be configured to perform wired communication via the terminal 112.

The memory section 103 may, as in the present example, comprise both volatile and non-volatile memory resources. By way of example, memory section 103 may comprise a working memory (e.g. a random access memory). In addition, the memory section 103 may include an instruction store (e.g. a ROM in the form of an electrically-erasable programmable read-only memory (EEPROM) or flash memory) storing a computer program comprising the computer-readable instructions which, when executed by the control section 101, cause the control section 101 to perform various functions. The memory section 103 may further comprise memory resources for storing additional information, such as, for example, information relating to the at least one sensor 106 and/or information for use in establishing a wireless communication link with a paired aerosol generation device case.

The memory section 103 may store a computer program comprising instructions which, when executed by the control section 101, cause the control section 101 to perform any of the methods described below in relation to FIGS. 5 to 11.

The output section 104 may, as in the present example embodiment, comprise any means known in the art suitable for outputting information to a user. By way of example, the outputting section may comprise one or multiple units including one or more of a display unit (e.g. an LCD screen or a touchscreen), a speaker unit (e.g. one or more of loudspeakers (e.g. one or more of moving coil loudspeakers, buzzers, horns and sounders), a lighting unit (e.g. one or more LEDs), and a haptic feedback unit (e.g. an eccentric rotating mass, ERM, vibration motor and/or a linear resonant actuator, LRA, vibration motor).

The input section 105 may, as in the present example embodiment, comprise means for allowing the aerosol generation device 100 to receive input from a user of the aerosol generation device 100. By way of non-limiting example, the power supply unit 110 may comprise a button 11 as shown in FIG. 1. Alternatively, the aerosol generation device 100 may comprise any suitable input means such as one or more additional buttons, one or more switches, a touch pad or touch screen, or suitable combination of such input means.

In example embodiments, such as the present example embodiment, in which the aerosol generation device 100 comprises at least one sensor 106, the at least one sensor 106 may, for example, include an inhalation sensor for use in detecting an inhaling action by a user of the aerosol generation device 100 and/or one or more of voltage and current sensors for use in detecting charging and discharging of the power supply 111 and/or connection of another device via the terminal 112. In such example embodiments, the control section 101 may be configured to control the aerosol generation device 100 based on the output of the at least one sensor 106.

In FIG. 2, the Tx/Rx section 102, the output section 104, the input section 105 and the at least one sensor 106 are shown separately to the control section 101. Alternatively, one or more of these components may be integrated with the control section 101.

In addition, the components 101 to 106 shown in FIG. 2 may be provided in any of units 101, 102 and 103 of the aerosol generation device 100 of FIG. 1. By way of example, components 101 to 106 shown in FIG. 2 may be provided in the power supply unit 110 of the aerosol generation device 100. Although not shown in FIG. 2, each of the components 101 to 106 of the aerosol generation device 100 may receive power from the power supply 111.

FIG. 3 is a schematic illustration of a system 1 comprising the aerosol generation device 100 of FIG. 1 and an aerosol generation device case 200, according to an example aspect herein.

The aerosol generation device case 200 is also referred to herein as “case 200”. As shown in FIG. 3, the case 200 may comprise a cavity 210, a power supply 220, and a terminal 230.

The aerosol generation device case 200 may, as in the present example embodiment, be configured to receive all or part of the aerosol generation device 100 in the cavity 210 when the aerosol generation device is not in use.

The aerosol generation device case 200 shown in FIG. 3 may be described as a handheld, electronic device. The case 200 may, as in the present example embodiment, be configured to provide one or more functions. By way of example, a case 200 may, as in the present example embodiment, have a function of charging an aerosol generation device 100 received therein.

The case 200 may provide alternative or additional functions such as, for example, storing and protecting the aerosol generation device 100 when not in use (e.g. during transport), providing a user interface via which the user may use to configure the aerosol generation device 100 received therein, and/or providing terminals via which external entities (e.g. smart phones, laptops, etc.) may interact with the aerosol generation device 100 received therein.

The power supply 220 may, as in the present example embodiment, be a rechargeable power supply. The power supply 220 may, as in the present example embodiment, be a lithium ion battery. Alternatively, the power supply 111 may be, for example, a chargeable secondary battery or an electric double layer capacitor (EDLC).

By way of alternative, in other example embodiments, the case may not comprise a power supply 220 suitable for charging another device. By way of example, the case 200 may comprise a smaller power supply suitable for power the components of the case 200 only or may be configured to be connected to a mains power supply when in use.

In such example embodiments, the aerosol generation device 200 case may not have a function of charging an aerosol generation device received therein. Alternatively, in such example embodiments, the case 200 may be configured to provide a charging function by providing any converting and/or rectifying means necessary for the power supply 111 of the aerosol generation device 100 to be charged from a mains power supply.

The terminal 230 may, as in the present example embodiment, comprise a power terminal for use in charging the power supply 111 of the aerosol generation device 100 when it is received in the cavity 210. That is, the terminal 230 may, as in the present example embodiment, be connectable to the aerosol generation device 100 and be configured to supply power to charge the power supply 111 of the aerosol generation device 100.

Additionally or alternatively, the terminal 230 may, as in the present example embodiment, comprise a data terminal to enable transmission of data to and reception of data from an external device connected to the case 200 via the terminal 230.

By way of example, the terminal 230 may include one or more of a USB terminal, a micro USB terminal, a wireless charging terminal, etc.

Case 200 may, as in the present example embodiment, be configured such that the terminal 230 is connected to the terminal 112 of the aerosol generation device 100 when the aerosol generation device 100 is received in the cavity 210. By way of example, the terminal 112 and the terminal 230 may be configured to provide an electrical connection between the aerosol generation device 100 and the case 200 for transfer of power and/or data.

Additionally or alternatively, the terminal 112 and the terminal 230 may be configured to provide a physical, mechanical connection between the aerosol generation device 100 and the aerosol generation device 200. This may be advantageous in order securely store the aerosol generation device 100 in the case 200, for example, during transport.

Additionally, in example embodiments such as the present example embodiment, in which the case 200 comprises a rechargeable power supply 220, the case 200 may comprise an additional terminal (not shown) for use in charging the power supply 220.

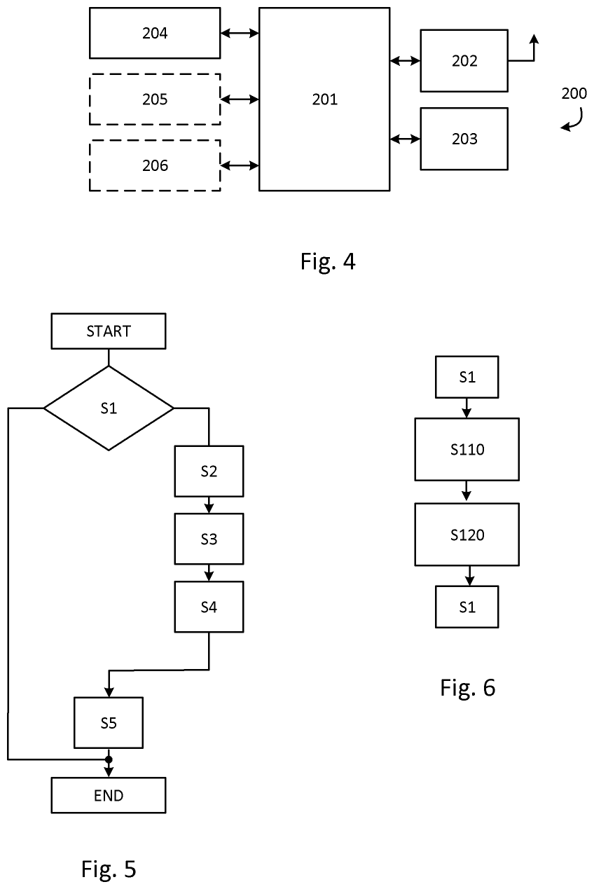

FIG. 4 is a block diagram illustrating components of a case 200, in accordance with an example aspect herein.

As shown in FIG. 4, the case 200 includes a control section 201, transmission/reception (Tx/Rx) section 202, and a memory section 203. Additionally, the case 200 may, as in the present example embodiment, comprise an output section 204 and, optionally, an input section 205 and/or at least one sensor 206.

The above description of the control section 101 of the aerosol generation device 100 applies mutatis mutandis to the control section 201 of the case 200.

The above description of the Tx/Rx section 102 of the aerosol generation device 100 applies mutatis mutandis to the Tx/Rx section 202 of the case 200.

The above description of the memory section 103 of the aerosol generation device 100 applies mutatis mutandis to the memory section 203 of the case 200. The memory section 203 may store a computer program comprising instructions which, when executed by the control section 201, cause the control section 201 to perform any of the methods described below in relation to FIGS. 12 to 18.

The above description of the output section 104 of the aerosol generation device 100 applies mutatis mutandis to the output section 204 of the case 200.

The above description of the input section 105 of the aerosol generation device 100 applies mutatis mutandis to the input section 205 of the case 200.

In example embodiments, such as the present example embodiment, in which the case 200 comprises at least one sensor 206, the at least one sensor 206 may, for example, include one or more of voltage and current sensors for use in detecting charging and discharging of the power supply 220 and/or connection of another device via the terminal 230. In such example embodiments, the control section 201 may be configured to control the case 200 based on the output of the at least one sensor 206.

In FIG. 4, the Tx/Rx section 202, the output section 204, the input section 205 and the at least one sensor 206 are shown separately to the control section 201. Alternatively, one or more of these components may be integrated with the control section 201. Although not shown in FIG. 4, each of the components 201 to 206 of the case 200 may receive power from the power supply 220.

As discussed above, the present inventors have recognised that various problems may arise in the use of an aerosol generation device having an aerosol generation device case.

Accordingly, FIG. 5 is a flow diagram illustrating a process by which the 1 may establish a wireless aerosol generation device 100 of Figure communication link with a paired aerosol generation device case, in accordance with an example aspect herein.

In process step S1 of FIG. 5, the control section 101 determines whether the aerosol generation device 100 is connected to a case 200 for a first time.

For example, the aerosol generation device 100 may be considered to be connected to the case 200 in a case where some form of electrical connection is established between the two devices that is detectable by the control section 101 (e.g. based on a received signal or the output of one or more voltage or current sensors).

By way of more detailed example, the aerosol generation device 100 may be considered to be connected to the case 200 in a case where the aerosol generation device 100 is received in the cavity 210 of the case 200 and an electrical connection is established between the terminal 112 and the terminal 230.

The aerosol generation device 100 may be considered to be connected to the case 200 for the first time, by way of example, in a case where the aerosol generation device 100 and case 200 are not currently paired (i.e. one or both devices do not store the other devices identifier and/or a wireless communication link is not already established between the two devices).

By way of example, FIG. 6 is a flow diagram showing an exemplary process by which the control section 101 may determine whether the aerosol generation device is connected to the case for a first time.

In process step S110 of FIG. 6, the control section 101 determines whether the identifier of the case 200 is previously stored in the memory section 103.

In process step S120 of FIG. 6, the control section 101 determines that the aerosol generation device 100 is connected to the case 200 for a first time in a case where the identifier of case 200 is not previously stored in the memory section 103.

Returning to FIG. 5, aerosol generation device 100 may preferably be considered to be connected to the case 200 for the first time only in a case where the aerosol generation device 100 is not currently paired with any case (i.e. the aerosol generation device 100 does not store an identifier of and/or a wireless communication link is not already established with any aerosol generation device case).

This may be advantageous in order to ensure that the aerosol generation device 100 is paired with a single case 200 only, thereby reliably ensuring that the aerosol generation device 100 cannot subsequently pair with, e.g., someone else's aerosol generation device case by accident.

Additionally, process step S1 may, as in the present example embodiment, optionally include receiving from the case 200 information indicating a corresponding determination result by the case 200 and the aerosol generation device 100 may only determine that it is connected to the case 200 for the first time if both devices determine that this is a first connection.

In a case where the aerosol generation device 100 is connected to the case 200 for a first time, the control section 101 pairs with the case 200.

The pairing may, as in the present example embodiment, be performed via a physical data connection. By way of example, pairing may be performed by the control section 101 controlling the Tx/Rx section 102 to transmit and receive data via the terminals 112 and 230. More generally, pairing may be performed by any suitable communication means described above in relation to FIGS. 1 and 3.

In particular, in order to pair with the case 200, in process step S2 of FIG. 5, the control section 101 controls the Tx/Rx section 102 to transmit, to the case 200, an identifier of the aerosol generation device 100.

In general, the identifier of the case 200 may comprise any information that allows the case 200 to be uniquely identified and may be composed of may be composed of alphanumeric characters, a binary value, or the like.

In process step S3 of FIG. 5, the control section 101 controls the Tx/Rx section 102 to receive, from the case 200, an identifier of the case 200.

In general, the identifier of the aerosol generation device 100 may comprise any information that allows the aerosol generation device 100 to be uniquely identified and may be composed of may be composed of alphanumeric characters, a binary value, or the like.

In process step S4 of FIG. 5, the control section 101 stores the received identifier in the memory section 103 of the aerosol generation device 100.

In process step S5 of FIG. 5, the aerosol generation device 100 establishes a wireless communication link with the paired case 200.

Both pairing and process step S5 may, as in the present example embodiment, be performed while the aerosol generation device 100 is connected to the case 200 for the first time.

Alternatively, process step S5 may be performed even when the aerosol generation device 100 and the case 200 are no longer connected. That is, in some example embodiments, it may only be necessary for the aerosol generation device 100 and the case 200 to be connected during process steps S1 to S4 of FIG. 5.

The established wireless communication link may comprise a communication link according to any suitable wireless communication means described above in relation to FIGS. 1 and 3 (e.g. Bluetooth™, RF, NFC, LTE or 5G IoT etc.).

The wireless communication link may, as in the present example embodiment, be established with the paired case 200 such that the wireless communication link persists even when the aerosol generation device 100 and the case 200 are no longer connected. By way of example, the wireless communication link may persist as long as the case 200 is within communication range of the aerosol generation device 100 based on the wireless technology used.

Accordingly, the process of FIG. 3 causes a pairing to be established between the aerosol generation device 100 and the case 200 when the aerosol generation device 100 is connected to the case 200 for a first time. The pairing requires a two-way exchange of identifiers between the aerosol generation device 100 and the case 200 such that an identifier of the aerosol generation device 100 is provided to the case 200 for storing and an identifier of the case 200 is provided to the aerosol generation device 100 for storing. A wireless communication is then established between the paired devices.

As such, even when the aerosol generation device 100 is in use or otherwise not connected to the case 200, the aerosol generation device 100 and case 200 may interact via the wireless communication link. Furthermore, as each of the aerosol generation device 100 and the case 200 is provided with the other device's identifier, the paired aerosol generation device 100 and case 200 are enabled to recognise one another when they are reconnected at a subsequent time.

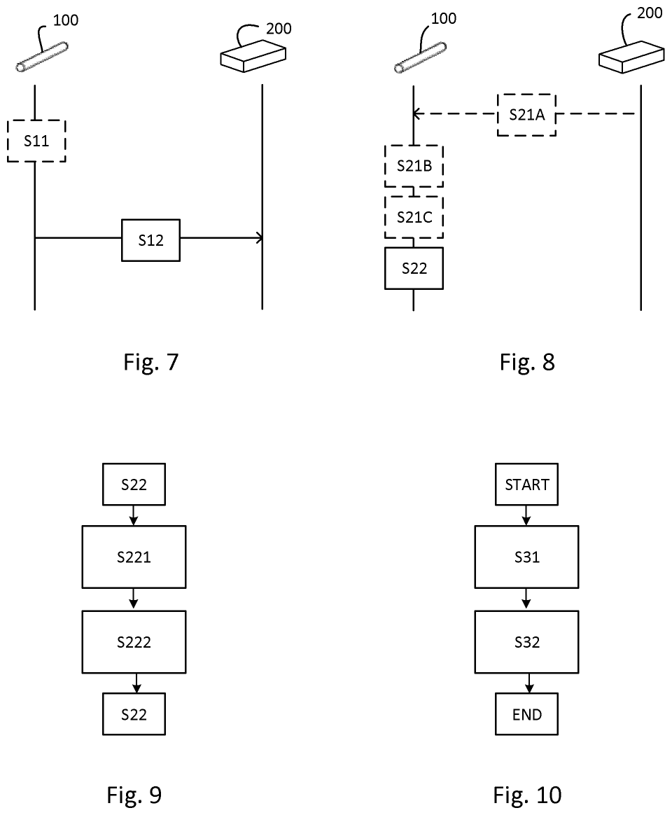

As such, the established pairing and wireless communication link may enable problems such as, for example, assisting a user in finding their case 200 or their aerosol generation device 100 when one of them is lost, alerting a user that either the case 200 or aerosol generation device 100 has been left behind, and/or ensuring that a user doesn't mistake someone else's case 200 or aerosol generation device 100 for their own to be addressed. Exemplary applications of the pairing and wireless communication link to such problems will be described in more detail in reference to FIGS. 7 to 11 below.

In addition, the established pairing and wireless communication link may enable interaction between the aerosol generation device 100 and the case 200, even when these devices are not connected, without relying on any additional external devices (e.g. an application on a mobile phone or tablet or connection to a server) in order to address such problems. Furthermore, the pairing and wireless communication link disclosed herein may be implemented using technologies that are generally included in and compatible with aerosol generation devices and cases, and do not require large amounts of additional hardware or complex software to implement, which may contribute to providing lower-cost and non-complex devices, as well as maintaining relatively simply manufacturing processes.

FIG. 7 is a flow diagram illustrating a first process performed by the aerosol generation device 100 of FIG. 1 that has established a wireless communication link with the case 200 of FIG. 3.

In optional process step S11 of FIG. 7, the control section 101 receives a user input via the input section 105 of the aerosol generation device 100. For example, the user may provide input via the input section 105 in a case where the user is unable to locate the case 200.

By way of example, in the present example embodiment, the user may provide input by pressing the button 113 on the aerosol generation device 100 one or more times. The number of times the button is to be pressed and how the button is to be pressed (e.g. a simple press or hold down for a given amount of time) in order to be recognised as a particular instruction may be stored in advance in the aerosol generation device 100 as part of its operating instructions. Alternatively, user input may be received in any form suitable for any of the input sections 105 discussed above in relation to FIG. 2.

In process step S12 of FIG. 7, the control section 101 controls the Tx/Rx section 102 to transmit, via the wireless communication link to the case 200, an instruction to output an alert.

The instruction may, as in the present example embodiment, specify a type of alert to be output by the case 200. For example, the type may be defined in advance or specified as part of the user input, and may specify any of the output sections 104 and 204 discussed above in relation to FIGS. 2 and 4. Alternatively, instruction may not specify the type of alert to be output and this may instead be determined at the case 200 side.

In embodiments such as the present example embodiment which include optional process step S11, the instruction is transmitted in response to receiving the user input.

Alternatively, the aerosol generation device 100 may be configured to transmit the instruction in response to a detected signal strength of a signal received from the case 200 falling below a threshold value. By way of example, the threshold value may be set such that the aerosol generation device 100 is caused to transmit an instruction while the detected signal strength is still sufficiently strong to allow reliable transmission to the case 200. This may be advantageous in cases where the wireless communication link has a limited range, in order to avoid attempts to transmit the instruction only after the case 200 is out of range.

By way of further alternative, the aerosol generation device 100 may be configured to transmit the instruction in response to determining that the aerosol generation device 100 and its case 200 have not been connected for more than a set time value. This time value may be set, for example, based on the battery capacity of the aerosol generation device 100 or the case 200 in order to ensure that the instruction is sent while both devices have sufficient power.

FIG. 8 is a flow diagram illustrating a second process performed by the aerosol generation device 100 of FIG. 1 that has established a wireless communication link with the case 200 of FIG. 3.

In optional process step S21A, the control section 101 controls the Tx/Rx section 102 to receive an instruction via the wireless communication link from the case 200. The description of the instruction in relation to process step S12 of FIG. 7 applies mutatis mutandis to process step S21A.

In optional process step S21B, the control section 101 determines that the wireless communication link with the case 200 is lost.

The control section 101 may, as in the present example embodiment, determine that the wireless communication link with the case 200 is lost in one or more of the following cases:
(i). The detected signal strength of a signal received from the case 200 is less than a threshold value.
(ii). A response signal is not received from the case 200 within a predetermined period of time after transmission of a signal by the aerosol generation device 100.
(iii). A signal is not received from the case 200 within a predetermined period of time after reception of a previous signal.

In optional process step S21C, the control section 101 receives a user input via the input section 105 of the aerosol generation device 200. The description of process step S11 of FIG. 7 applies mutatis mutandis to process step S21C.

In process step S22, the control section 101 outputs an alert via the output section 104 of the aerosol generation device 100. The alert may be in any suitable form that can be output by the output section, examples of which are described above in relation to FIG. 2.

By way of example, outputting the alert via the output section 104 may, as in the present example embodiment, comprise at least one of the following:
(i). Outputting a sound via a speaker unit;
(ii). Emitting a light via a lighting unit;
(iii). Blinking or adjusting a brightness of a light emitted by a lighting unit; and
(iv). outputting a vibration via a haptic feedback unit.

The control section 101 may, as in the present example embodiment, output the alert in response to the occurrence of any of process steps S21A, S21B and S21C. By way of example, in a case where optional process step S21A is performed, the alert is output in response to the received instruction.

The output alert may, as in the present example embodiment, have different forms depending on which of optional process steps 21A to 21C trigger the outputting of the alert. Alternatively, the alert may have the same form in all cases or may be dependent on other factors (e.g. battery levels or preconfigured user preferences).

In a case where optional process step S21B is performed, the alert is output in response to the determination that the wireless communication link with the case 200 is lost. The loss of wireless communication link may be indicative of the case 200 and the aerosol generation device 100 being moved out of communication range, for example, when a user leaves one of the devices behind at a previous location or otherwise mislays that device. In a case where the case 200 has been left behind, the alert output by the aerosol generation device 100 may prompt the user to return to the location to retrieve the case 200. In a case where the aerosol generation device 100 is left behind or otherwise mislaid, the output alert may assist the user to locate the aerosol generation device 100.

In a case where optional process step S21C is performed, the alert is output in response to the received user input. By way of example, in a case where the case 200 is lost, a user may provide user input in order to instruct the aerosol generation device 100 to output an alert that is modulated based on the intensity or strength of the signal connecting the aerosol generation device 100 and the case, in order to provide the user with an indication of the proximity of the case 200. This may assist the user to locate the case 200.

FIG. 9 is a flow diagram illustrating a process by which the control section 101 may output the alert via the output section 104 of the aerosol generation device 100 in response to the received user input.

In process step S221 of FIG. 9, the control section 101 detects a signal strength of a signal received from the case 200. By way of example, the aerosol generation device 100 may be provided with any means necessary to measure/detect the intensity, SIR, SINR, or other measure of quality or strength of a received signal known to those versed in the art.

In process step S222 of FIG. 9, the control section 101 adjusts the alert based on the detected signal strength.

By way of example, the control section 101 may, as in the present example embodiment, be configured to increase an intensity of the alert as the detected signal strength increases. By way of more specific example, in a case where the alert comprises a sound output via a speaker unit, the volume of the sound may be increased with increasing detected signal strength, or, in a case where the alert comprises blinking of a light emitted by a lighting unit, the rate of the blinking may be increased with increasing detected signal strength.

FIG. 10 is a flow diagram illustrating a third process performed by the aerosol generation device 100 of FIG. 1 that has established a wireless communication link with the case 200 of FIG. 3.

The process of FIG. 10 is performed in order for the aerosol generation device 100 to unpair with the case 200. This may also be referred to as resetting the pairing.

In process step S31 of FIG. 10, the control section 101 receives a user input via the input section 104 of the aerosol generation device 100.

By way of example, in the present example embodiment, the user may provide input by pressing the button 113 on the aerosol generation device 100 one or more times. The number of times the button is to be pressed and how the button is to be pressed (e.g. a simple press or hold down for a given amount of time) in order to be recognised as a particular instruction may be stored in advance in the aerosol generation device 100 as part of its operating instructions. Alternatively, user input may be received in any suitable for any of the input sections 105 discussed above in form relation to FIG. 2.

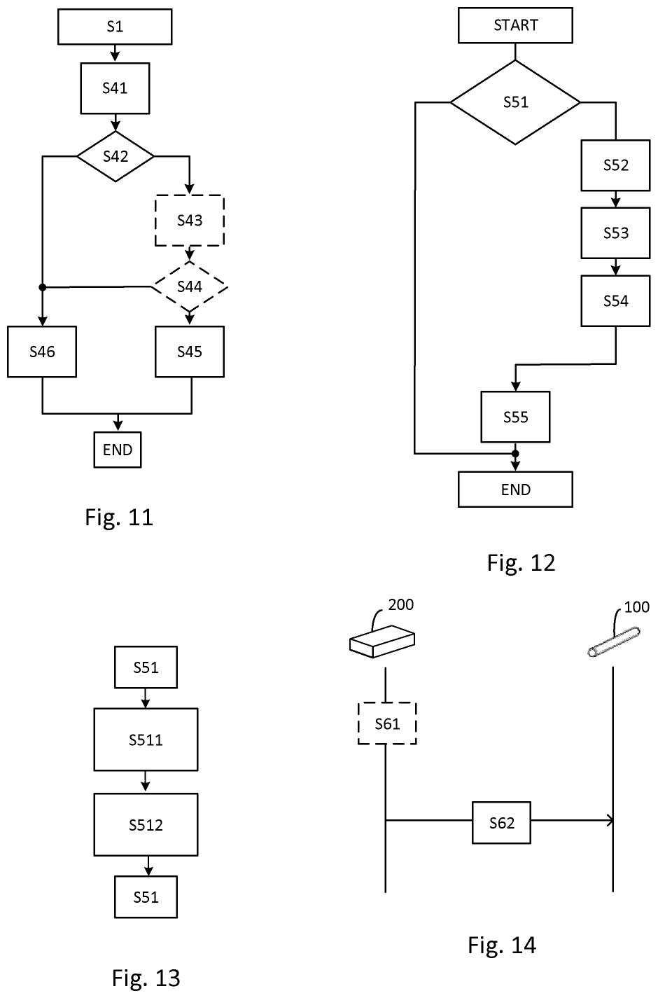

In process step S32 of FIG. 11, the control section 101 deletes the received identifier from the memory section 103 in response to the received user input.

The control section 101 may, as in the present example embodiment, be configured to delete the received identifier from the memory section 103 while the aerosol generation device 100 is not connected to the case 200. Preferably, control section 101 may be configured such that resetting of the pairing is only possible when the aerosol generation device 100 and the case 200 are not connected. This may offer a low-complexity means of ensuring that the aerosol generation device 100 and the case 200 do not automatically perform pairing after the initial pairing is reset.

As will be described below in relation to FIG. 17, the user may also provide input to instruct the case 200 to unpair from the aerosol generation device 100, for example, at the same time.

By unpairing with the case 200, the aerosol generation device 100 may pair with and establish a wireless communication link with the case 200 or another aerosol generation device case at a next connection to that aerosol generation device case in accordance with the process of FIG. 3. Accordingly, the user may easily and conveniently configure the aerosol generation device 100 for use with a new aerosol generation device case and/or configure the case 200 for use with a new aerosol generation device, as well as allowing the aerosol generation device 100 and the case 200 to be easily and conveniently paired again.

FIG. 11 is a flow diagram illustrating a fourth process performed by the aerosol generation device 100.

The process of FIG. 11 is performed in response to a determination in process step S1 of FIG. 5 that the aerosol generation device 100 is not connected to the case 200 for a first time. That is, the control section 101 determines that it is not the first time that the aerosol generation device 100 is connected to a case 200 because, for example, the aerosol generation device 100 already stores an identifier of an aerosol generation device case in the memory section 103 and/or a wireless communication link is already established with an aerosol generation device case.

In process step S41 of FIG. 11, the control section 101 controls the Tx/Rx section 102 to receive, from the case 200, an identifier of the case 200.

In process step S42 of FIG. 11, the control section 101 determines whether the received identifier matches a first identifier stored in the memory section 103. By way of example, the received identifier may be determined to match the first identifier in a case where both of the identifiers have the same value (i.e. are identical).

By way of further example, the first identifier stored in the memory section 103 may, as in the present example embodiment, be an identifier of an aerosol generation device case (which may or may not be the case 200) received as part of pairing during a first connection of the aerosol generation device 100. Alternatively, the first identifier may be input by the user via the input section 105 in advance in order to identify their aerosol generation device case.

In a case where the received identifier does not match the first identifier stored in the memory section 103, the process of FIG. 11 proceeds to process step S46. In a case where the received identifier matches the first identifier stored in the memory section 103, the process of FIG. 11 proceeds to optional process step S43.

In optional process step S43 of FIG. 11, the control section 101 controls the Tx/Rx section 102 to transmit the identifier of the aerosol generation device 100 to the case 200.

In optional process step S44 of FIG. 11, the control section 101 determines whether a signal is received from the case 200 indicating that the verification has failed.

If the control section 101 determines that a signal indicating that the verification has failed has been received from the case 200, the process of FIG. 11 proceeds to process step S46.

If the control section 101 determines that a signal indicating that the verification has failed has not been received from the case 200 (e.g. no signal is received or a signal indicating that the verification has succeeded is received), the process of FIG. 11 proceeds to process step S45. Alternatively, in embodiments in which optional process steps S43 and S44 are not included, the process of FIG. 11 may proceed to process step S45 if the control section 101 determines that the received identifier matches a first identifier stored in the memory section 103 in process step S42.

In process step S45 of FIG. 11, the control section 101 determines that the verification is successful. That is, the control section 101 determines that the case 200, with which it is currently connected, is that with which it was previously paired based on the first identifier stored in the memory section 103 and, optionally, on the feedback from the case 200.

If verification proceeds, the aerosol generation device 100 may, for example, continue to interact with the case 200 via a previously established wireless communication link or re-establish the wireless communication link if it was lost at some point after the first connection.

In process step S46 of FIG. 11, the control section 101 determines that verification has failed. That is, one or both of aerosol generation device 100 and the case 200 does not store the other device's identifier in its memory section.

Optionally, in a case where verification has failed, the control section 101 may be configured to output an alert via the output section 104 of the aerosol generation device 100. In this way, the user may be informed of the verification failure.

Additionally or alternatively, in a case where verification has failed, the control section 101 may optionally be configured to disable charging of the aerosol generation device 100.

Verification failure may occur, for example, where the aerosol generation device 100 is paired with a different aerosol generation device case, where the case 200 is paired with a different aerosol generation device, or where the pairing has been reset in one of the aerosol generation device 100 and the case 200 but not in the other.

Accordingly, the two-way exchange of identifiers as part of the pairing performed in the process of FIG. 3 enables both the aerosol generation device 100 and the case 200 to recognise its paired device. This may be advantageous compared to solutions in which, for example, only the aerosol generation device case stores an identifier of the aerosol generation device. In this case, it would not be possible to for the aerosol generation device to recognise its paired case and, as such, the user may accidentally take and use someone else's case (particularly if this other case is not currently paired) and accidently leave their own case behind.

This may also be advantageous over conventional solutions in which an identifier of the user is used to associate the aerosol generation device and aerosol generation device case. In particular, in such solutions, it may not be possible for the aerosol generation device to distinguish between multiple cases belonging to the user and vice versa, and therefore it cannot be ensured that the correct aerosol generation device and case are used together, thereby making it more difficult for a user to keep track of their devices.

Furthermore, by performing pairing only a case where the aerosol generation device 100 is connected to the case 200 for a first time, it can be ensured that the aerosol generation device is paired with the correct aerosol generation device case. This may also avoid the need on the part of the user to input the identifiers of two devices to be paired manually, thereby avoiding a potential source of errors.

Additionally, it can be ensured that a wireless communication link is only established with paired devices. This may in turn help to ensure that information can only be exchanged between the paired devices and/or limit the amount of information that can be exchanged between connected devices before pairing. This may be advantageous in order to increase the security of any information of the user stored on either device (e.g. biometric data or other data identifying the user).

FIG. 12 is a flow diagram illustrating a process by which the case 200 of FIG. 3 may establish a wireless communication link with a paired aerosol generation device 100, in accordance with an example aspect herein.

In process step S51 of FIG. 12, the control section 201 determines whether the case 200 is connected to an aerosol generation device 100 for a first time. The description of process step S1 of FIG. 5 applies mutatis mutandis to process step S51.

FIG. 13 is a flow diagram illustrating an exemplary process by which the control section 201 may determine whether the case 200 is connected to the aerosol generation device 100 for a first time.

In process step S511 of FIG. 13, the control section 201 determines whether the identifier of the aerosol generation device 100 is previously stored in the memory section 203.

In process step S512 of FIG. 13, the control section 201 determines that the case 200 is connected to the aerosol generation device 100 for a first time in a case where the identifier of aerosol generation device 100 is not previously stored in the memory section 203.

Returning to FIG. 12, in a case where the case 200 is connected to the aerosol generation device 100 for a first time, the control section 201 pairs with the aerosol generation device 100.

The pairing may, as in the present example embodiment, be performed via a physical data connection. By way of example, pairing may be performed by the control section 201 controlling the Tx/Rx section 202 to transmit and receive data via the terminals 112 and 230. More generally, pairing may be performed by any suitable communication means described above in relation to FIGS. 1 and 3.

In particular, in order to pair with the aerosol generation device 100, in process step S52 of FIG. 12, the control section 201 controls the Tx/Rx section 202 to transmit, to the aerosol generation device 100, an identifier of the case 200. The description of process step S2 of FIG. 5 applies mutatis mutandis to process step S52.

In process step S53 of FIG. 12, the control section 201 controls the Tx/Rx section 202 to receive, from the aerosol generation device 100, an identifier of the aerosol generation device 100. The description of process step S3 of FIG. 5 applies mutatis mutandis to process step S53.

In process step S54 of FIG. 12, the control section 201 stores the received identifier in the memory section 203 of the case 200.

In process step S55 of FIG. 5, the case 200 establishes a wireless communication link with the paired aerosol generation device 100. The description of process step S5 of FIG. 5 applies mutatis mutandis to process step S55.

The description of the advantages provided by the process of FIG. 5 applies mutatis mutandis to the process of FIG. 12.

FIG. 14 is a flow diagram illustrating a first process performed by the case 200 of FIG. 3 that has established a wireless communication link with the aerosol generation device 100 of FIG. 1.

In optional process step S61 of FIG. 14, the control section receives a user input received via the input section 205 of the case 200. The description of process step S11 of FIG. 7 applies mutatis mutandis to process step S61.

In process step S62 of FIG. 14, the control section 201 controls the Tx/Rx section 202 to transmit, via the wireless communication link to the aerosol generation device 100, an instruction to output an alert. Optionally, in embodiments such as the present example embodiment which include optional process step S61, the instruction is transmitted in response to the received user input.

In general, the description of process step S12 of FIG. 7 applies mutatis mutandis to process step S62.

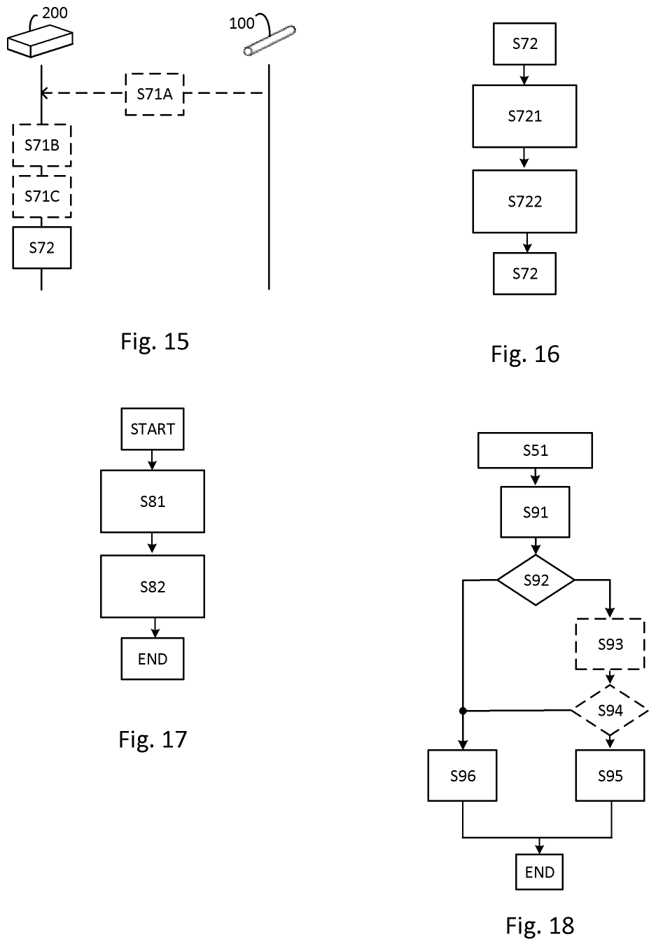

FIG. 15 is a flow diagram illustrating a second process performed by the case 200 of FIG. 3 that has established a wireless communication link with the aerosol generation device 100 of FIG. 1.

In optional process step S71A of FIG. 15, the control section 201 controls the Tx/Rx section 202 to receive an instruction via the wireless communication link from the aerosol generation device 100. The description of the instruction in relation to process step S12 of FIG. 7 applies mutatis mutandis to process step S71A.

In optional process step S71B of FIG. 15, the control section 201 determines that the wireless communication link with the aerosol generation device 100 is lost.

The control section 201 may, as in the present example embodiment, determine that the wireless communication link with the aerosol generation device 100 is lost in one or more of the following cases:
(i). A detected signal strength of a signal received from the aerosol generation device 100 is less than a threshold value.
(ii). A response signal is not received from the aerosol generation device 100 within a predetermined period of time after transmission of a signal by the case 200.
(iii). A signal is not received from the aerosol generation device 100 within a predetermined period of time after reception of a previous signal.

In optional process step S71C of FIG. 15, the control section 201 receives a user input via the input section 205 of the case 200. The description of process step S11 of FIG. 7 applies mutatis mutandis to process step S71C.

In process step S72 of FIG. 15, the control section 201 outputs an alert via the output section 204 of the case 200.

In a case where optional process step S71A is performed, the alert is output in response to the received instruction. In a case where optional process step S71B is performed, the alert is output in response to the determination that the wireless communication link with the aerosol generation device 100 is lost. In a case where optional process step S71C is performed, the alert is output in response to the received user input.

Outputting the alert via the output section 204 may, as in the present example embodiment, comprise at least one of the following means:
(i). outputting a sound via a speaker unit;
(ii). emitting a light via a lighting unit;
(iii). Blinking or adjusting a brightness of a light emitted by a lighting unit; and
(iv). outputting a vibration via a haptic feedback unit.

FIG. 16 is a flow diagram illustrating an exemplary process by which the control section 201 may output the alert via the output section 204 in response to the received user input.

In process step S721 of FIG. 16, the control section 201 detects a signal strength of a signal received from the aerosol generation device 100. The description of process step S221 of FIG. 9 applies mutatis mutandis to process step S721.

In process step S722 of FIG. 16, the control section 201 adjusts the alert based on the detected signal strength. The description of process step S222 of FIG. 9 applies mutatis mutandis to process step S722.

More generally, the description of process step S22 of FIG. 8 and the advantages provided thereby applies mutatis mutandis to process step S72.

FIG. 17 is a flow diagram illustrating a third process performed by the case 200 of FIG. 3 that has established a wireless communication link with the aerosol generation device 100 of FIG. 1.

The process of FIG. 17 is performed in order for the case 200 to unpair with aerosol generation device 100. This may also be referred to as resetting the pairing.

In process step S81 of FIG. 17, the control section 201 receives a user input via the input section 205 of the case 200. The description of process step S31 of FIG. 10 applies mutatis mutandis to process step S781.

In process step S82 of FIG. 17, the control section 201 deletes the received identifier from the memory section 203 in response to the received user input. The description of process step S32 of FIG. 10 applies mutatis mutandis to process step S82.

FIG. 18 is a flow diagram illustrating a fourth process performed by the case 200 of FIG. 3.

The process of FIG. 18 is performed in response to a determination in process step S51 of FIG. 12 that the case 200 is not connected to the aerosol generation device 100 for a first time. That is, the control section 201 determines that it is not the first time that the case 200 is connected to the aerosol generation device 100 because, for example, the case 200 already stores an identifier of an aerosol generation device in the memory section 203 and/or a wireless communication link is already established with an aerosol generation device.

In process step S91 of FIG. 18, the control section 201 controls the Tx/Rx section 202 to receive, from the aerosol generation device 100, an identifier of the aerosol generation device 100.

In process step S92 of FIG. 18, the control section 201 determines whether the received identifier matches a first identifier stored in the memory section 203. The description of process step S42 of FIG. 11 applies mutatis mutandis to process step S92.

In a case where the received identifier does not match the first identifier stored in the memory section 203, the process of FIG. 18 proceeds to process step S96. In a case where the received identifier matches the first identifier stored in the memory section 203, the process of FIG. 18 proceeds to optional process step S93.

In optional process step S93 of FIG. 18, the control section 201 controls the Tx/Rx section 202 to transmit the identifier of the case 200 to the aerosol generation device 100.

In optional process step S94 of FIG. 18, the control section 201 determines whether a signal is received from the aerosol generation device 100 indicating that the verification has failed.

If the control section 201 determines that a signal indicating that the verification has failed has been received from the aerosol generation device 100, the process of FIG. 18 proceeds to process step S96.

If the control section 201 determines that a signal indicating that the verification has failed has not been received from the aerosol generation device 100 (e.g. no signal is received or a signal indicating that the verification has succeeded is received), the process of FIG. 18 proceeds to process step S95. Alternatively, in embodiments in which optional process steps S93 and S94 are not included, the process of FIG. 18 may proceed to process step S95 if the control section 201 determines that the received identifier matches a first identifier stored in the memory section 203 in process step S92.

In process step S95 of FIG. 19, the control section 101 determines that the verification is successful. The description of process step S45 of FIG. 11 applies mutatis mutandis to process step S95.

In process step S96 of FIG. 18, the control section 201 determines that verification has failed. That is, one or both of aerosol generation device 100 and the case 200 does not store the other device's identifier in its memory section.

Optionally, in a case where verification has failed, the control section 201 may be configured to output an alert via the output section 204 of the case 200. In this way, the user may be informed of the verification failure.

Additionally or alternatively, in a case where verification has failed, the control section 201 may optionally be configured to disable charging of the aerosol generation device 100.

Although detailed embodiments have been described, they only serve to provide a better understanding of the invention defined by the independent claims, and are not to be seen as limiting.

Further embodiments are described as E1 to E37 below:

E1. A method of an aerosol generation device comprising:
determining whether the aerosol generation device is connected to an aerosol generation device case for a first time;
in a case where the aerosol generation device is connected to the aerosol generation device case for a first time, pairing with the aerosol generation device case by:
   transmitting, to the aerosol generation case, an identifier of the aerosol generation device;
   receiving, from the aerosol generation device case, an identifier of the aerosol generation device case;
   storing the received identifier in a memory section of the aerosol generation device; and
   establishing a wireless communication link with the paired aerosol generation device case.

E2. The method of E1, wherein determining whether the aerosol generation device is connected to the aerosol generation device case for a first time comprises:
determining whether the identifier of the aerosol generation device case is previously stored in the memory section, and
determining that the aerosol generation device is connected to the aerosol generation device case for a first time in a case where the identifier of aerosol generation device case is not previously stored in the memory section.

E3. The method of E1 or E2, wherein pairing is performed via a physical data connection.

E4. The method of any preceding embodiment, further comprising:
transmitting, via the wireless communication link to the aerosol generation device case, an instruction to output an alert.

E5. The method of E4, wherein the instruction is transmitted in response to a user input received via an input section of the aerosol generation device.

E6. The method of any preceding embodiment, further comprising:
outputting an alert via an output section of the aerosol generation device.

E7. The method of E6, wherein the alert is output in response to an instruction received via the wireless communication link from the aerosol generation device case.

E8. The method of E6, wherein the alert is output in response to a determination that the wireless communication link with the aerosol generation device case is lost.

E9. The method of E8, further comprising determining that the wireless communication link with the aerosol generation device case is lost in a case where:
a detected signal strength of a signal received from the aerosol generation device case is less than a threshold value;
a response signal is not received from the aerosol generation device case within a predetermined period of time after transmission of a signal by the aerosol generation device; and/or
a signal is not received from the aerosol generation device case within a predetermined period of time after reception of a previous signal.

E10. The method of E6, wherein the alert is output in response to a user input received via an input section of the aerosol generation device.

E11. The method of E10, further comprising:
detecting a signal strength of a signal received from the aerosol generation device case; and
adjusting the alert based on the detected signal strength.

E12. The method of any of E6 to E11, wherein outputting the alert via the output section comprises at least one of:
outputting a sound via a speaker unit;
emitting a light via a lighting unit;
blinking or adjusting a brightness of a light emitted by a lighting unit; and
outputting a vibration via a haptic feedback unit.

E13. The method of any preceding embodiment further comprising:
unpairing with the aerosol generation device case by:
deleting the received identifier from the memory section in response to a user input received via an input section of the aerosol generation device.

E14. The method of E13, wherein the received identifier is deleted from the memory section while the aerosol generation device is not connected to the aerosol generation device case.

E15. The method of any preceding embodiment, further comprising, in a case where the aerosol generation device is not connected to the aerosol generation device case for a first time:
receiving, from the aerosol generation device case, an identifier of the aerosol generation device case;
determining whether the received identifier matches a first identifier stored in the memory section; and
determining verification has failed in a case where the received identifier does not match the first identifier stored in the memory section.

E16. The method of E15, further comprising, in a case where the aerosol generation device is not connected to the aerosol generation device case for a first time:
transmitting the identifier of the aerosol generation device to the aerosol generation device case; and
determining verification has failed in response to a signal received from the aerosol generation device case.

E17. The method of E15 or E16, further comprising, in a case where verification has failed, at least one of:
outputting an alert via an output section of the aerosol generation device; and
disabling charging of the aerosol generation device.

E18. A method of an aerosol generation device case comprising:
determining whether the aerosol generation device case is connected to an aerosol generation device for a first time;
in a case where the aerosol generation device case is connected to the aerosol generation device for a first time, pairing with the aerosol generation device by:
   transmitting, to the aerosol generation device, an identifier of the aerosol generation device case;
   receiving, from the aerosol generation device, an identifier of the aerosol generation device;
   storing the received identifier in a memory section of the aerosol generation device case; and
   establishing a wireless communication link with the paired aerosol generation device.

E19. The method of E18, wherein determining whether the aerosol generation device case is connected to the aerosol generation device for a first time comprises:
determining whether the identifier of the aerosol generation device is previously stored in the memory section, and
determining that the aerosol generation device case is connected to the aerosol generation device for a first time in a case where the identifier of aerosol generation device is not previously stored in the memory section.

E20. The method of E18 or E19, wherein pairing is performed via a physical data connection.

E21. The method of any of E18 to E20, further comprising:
transmitting, via the wireless communication link to the aerosol generation device, an instruction to output an alert.

E22. The method of E21, wherein the instruction is transmitted in response to a user input received via an input section of the aerosol generation device case.

E23. The method of any of E18 to E22, further comprising:
outputting an alert via an output section of the aerosol generation device case.

E24. The method of E23, wherein the alert is output in response to an instruction received via the wireless communication link from the aerosol generation device.

E25. The method of E23, wherein the alert is output in response to a determination that the wireless communication link with the aerosol generation device is lost.

E26. The method of E25, further comprising determining that the wireless communication link with the aerosol generation device is lost in a case where:
a detected signal strength of a signal received from the aerosol generation device is less than a threshold value;
a response signal is not received from the aerosol generation device within a predetermined period of time after transmission of a signal by the aerosol generation device case; and/or
a signal is not received from the aerosol generation device within a predetermined period of time after reception of a previous signal.

E27. The method of E23, wherein the alert is output in response to a user input received via an input section of the aerosol generation device case.

E28. The method of E27, further comprising:
detecting a signal strength of a signal received from the aerosol generation device; and
adjusting the alert based on the detected signal strength.

E29. The method of any of E23 to E28, wherein outputting the alert via the output section comprises at least one of:
outputting a sound via a speaker unit;
emitting a light via a lighting unit;
blinking or adjusting a brightness of a light emitted by a lighting unit; and
outputting a vibration via a haptic feedback unit.

E30. The method of any of E18 to E29 further comprising:
unpairing with the aerosol generation device by:
deleting the received identifier from the memory section in response to a user input received via an input section of the aerosol generation device case.

E31. The method of E30, wherein the received identifier is deleted from the memory section while the aerosol generation device case is not connected to the aerosol generation device.

E32. The method of any of E18 to E31, further comprising, in a case where the aerosol generation device case is not connected to the aerosol generation device for a first time:
receiving, from the aerosol generation device, an identifier of the aerosol generation device;
determining whether the received identifier matches a first identifier stored in the memory section; and
determining verification has failed in a case where the received identifier does not match the first identifier stored in the memory section.

E33. The method of E32, further comprising, in a case where the aerosol generation device case is not connected to the aerosol generation device for a first time:
transmitting the identifier of the aerosol generation device case to the aerosol generation device; and
determining verification has failed in response to a signal received from the aerosol generation device.

E34. The method of E32 or E33, further comprising, in a case where verification has failed, at least one of:
outputting an alert via an output section of the aerosol generation device case; and
disabling charging of the aerosol generation device.

E35. An aerosol generation device comprising:
a transmitting/receiving section;
a memory section; and
a control section configured to control the transmitting/receiving section and the memory section to perform the method of any of E1 to E17.

E36. An aerosol generation device case comprising:
a transmitting/receiving section;
a memory section; and
a control section configured to control the transmitting/receiving section and the memory section to perform the method of any of E18 to E34.

E37. A system comprising an aerosol generation device according to E35 and an aerosol generation device case according to E36.

E38. A method of an aerosol generation system comprising an aerosol generation device and an aerosol generation device case, the method comprising:
determining whether the aerosol generation device is connected to the aerosol generation device case for a first time;
in a case where the aerosol generation device is connected to the aerosol generation device case for a first time, pairing the aerosol generation device with the aerosol generation device case by exchanging an identifier of the aerosol generation device and an identifier of the aerosol generation device case; and
establishing a wireless communication link between the paired aerosol generation device and aerosol generation device case,
characterized by:
outputting an alert via an output section of the aerosol generation device and/or an output section of the aerosol generation device case in response to a determination that the wireless communication link with the aerosol generation device case is lost or in response to user input.

E39. The method of E38, further comprising:
outputting an alert via the output section of the aerosol generation device case in response to user input received on the aerosol generation device.

1-17. (canceled)

18. An aerosol generation device comprising:
a transmitting/receiving section;
a memory section; and
a control section, wherein the control section is configured to determine whether the aerosol generation device is connected to an aerosol generation device case for a first time,
wherein, in a case where the aerosol generation device is connected to the aerosol generation device case for a first time, the control section is configured to control the transmitting/receiving section and the memory section to pair with the aerosol generation device case by:
transmitting, to the aerosol generation device case, an identifier of the aerosol generation device;
receiving, from the aerosol generation device case, an identifier of the aerosol generation device case;
storing the received identifier in the memory section of the aerosol generation device; and
establishing a wireless communication link with the paired aerosol generation device case, and
wherein, in a case where the aerosol generation device is not connected to the aerosol generation device case for a first time, the control section is configured to control the transmitting/receiving section and the memory section to pair with the aerosol generation device case by:
receiving, from the aerosol generation device case, the identifier of the aerosol generation device case;
determining whether the received identifier matches a first identifier stored in the memory section; and
determining verification has failed in a case where the received identifier does not match the first identifier stored in the memory section.

19. The aerosol generation device of claim 18, wherein determining whether the aerosol generation device is connected to the aerosol generation device case for a first time comprises:
determining whether the identifier of the aerosol generation device case is previously stored in the memory section, and
determining that the aerosol generation device is connected to the aerosol generation device case for a first time in a case where the identifier of aerosol generation device case is not previously stored in the memory section.

20. The aerosol generation device of claim 18, wherein, in the case where the aerosol generation device is connected to the aerosol generation device case for a first time, the control section is configured to control the transmitting/receiving section and the memory section to:
transmit, via the wireless communication link to the aerosol generation device case, an instruction to output an alert,
wherein the instruction is transmitted in response to a user input received via an input section of the aerosol generation device.

21. The aerosol generation device of claim 18, wherein the control section is configured to control the transmitting/receiving section and the memory section to:
output an alert via an output section of the aerosol generation device.

22. The aerosol generation device of claim 21, wherein the alert is output in response to one of:
an instruction received via the wireless communication link from the aerosol generation device case; or
a user input received via an input section of the aerosol generation device.

23. The aerosol generation device of claim 21, wherein the alert is output in response to a determination that the wireless communication link with the aerosol generation device case is lost.

24. The aerosol generation device of claim 23, wherein the control section is configured to control the transmitting/receiving section and the memory section to determine that the wireless communication link with the aerosol generation device case is lost in a case where:
a detected signal strength of a signal received from the aerosol generation device case is less than a threshold value;
a response signal is not received from the aerosol generation device case within a predetermined period of time after transmission of a signal by the aerosol generation device; and/or
a signal is not received from the aerosol generation device case within a predetermined period of time after reception of a previous signal.

25. The aerosol generation device of claim 21, wherein the control section is configured to control the transmitting/receiving section and the memory section to:
detect a signal strength of a signal received from the aerosol generation device case; and
adjust the alert based on the detected signal strength.

26. The aerosol generation device of claim 18, wherein the control section is configured to control the transmitting/receiving section and the memory section to:
unpair with the aerosol generation device case by:
deleting the received identifier from the memory section in response to a user input received via an input section of the aerosol generation device.

27. The aerosol generation device of claim 18, wherein, in the case where the aerosol generation device is not connected to the aerosol generation device case for a first time, the control section is configured to control the transmitting/receiving section and the memory section to:
transmit the identifier of the aerosol generation device to the aerosol generation device case; and
determine verification has failed in response to a signal received from the aerosol generation device case.

28. An aerosol generation device case comprising:
a transmitting/receiving section;
a memory section; and
a control section, wherein the control section is configured to determine whether the aerosol generation device case is connected to an aerosol generation device for a first time,
wherein, in a case where the aerosol generation device case is connected to the aerosol generation device for a first time, the control section is configured to control the transmitting/receiving section and the memory section to pair with the aerosol generation device by:
transmitting, to the aerosol generation device, an identifier of the aerosol generation device case;
receiving, from the aerosol generation device, an identifier of the aerosol generation device;
storing the received identifier in the memory section of the aerosol generation device case; and
establishing a wireless communication link with the paired aerosol generation device, and
wherein, in a case where the aerosol generation device case is not connected to the aerosol generation device for a first time, the control section is configured to control the transmitting/receiving section and the memory section to pair with the aerosol generation device by:
receiving, from the aerosol generation device, the identifier of the aerosol generation device;
determining whether the received identifier matches a first identifier stored in the memory section; and
determining verification has failed in a case where the received identifier does not match the first identifier stored in the memory section.

29. The aerosol generation device case of claim 28, wherein determining whether the aerosol generation device case is connected to the aerosol generation device for a first time comprises:
determining whether the identifier of the aerosol generation device is previously stored in the memory section, and
determining that the aerosol generation device case is connected to the aerosol generation device for a first time in a case where the identifier of aerosol generation device is not previously stored in the memory section.

30. The aerosol generation device case of claim 28, wherein, in the case where the aerosol generation device case is connected to the aerosol generation device for a first time, the control section is configured to control the transmitting/receiving section and the memory section to:
transmit, via the wireless communication link to the aerosol generation device, an instruction to output an alert,
wherein the instruction is transmitted in response to a user input received via an input section of the aerosol generation device case.

31. The aerosol generation device case of claim 28, wherein the control section is configured to control the transmitting/receiving section and the memory section to:
output an alert via an output section of the aerosol generation device case.

32. The aerosol generation device case of claim 31, wherein the alert is output in response to one of:
an instruction received via the wireless communication link from the aerosol generation device; or
a user input received via an input section of the aerosol generation device case.

33. The aerosol generation device case of claim 31, wherein the alert is output in response to a determination that the wireless communication link with the aerosol generation device is lost.

34. The aerosol generation device case of claim 33, wherein the control section is configured to control the transmitting/receiving section and the memory section to determine that the wireless communication link with the aerosol generation device is lost in a case where:
a detected signal strength of a signal received from the aerosol generation device is less than a threshold value;
a response signal is not received from the aerosol generation device within a predetermined period of time after transmission of a signal by the aerosol generation device case; and/or
a signal is not received from the aerosol generation device within a predetermined period of time after reception of a previous signal.

35. The aerosol generation device case of claim 31, wherein the control section is configured to control the transmitting/receiving section and the memory section to:
detect a signal strength of a signal received from the aerosol generation device; and
adjust the alert based on the detected signal strength.

36. The aerosol generation device case of claim 28, wherein the control section is configured to control the transmitting/receiving section and the memory section to:
unpair with the aerosol generation device by:
deleting the received identifier from the memory section in response to a user input received via an input section of the aerosol generation device case.

37. The aerosol generation device case of claim 28, wherein, in the case where the aerosol generation device case is not connected to the aerosol generation device for a first time, the control section is configured to control the transmitting/receiving section and the memory section to:
transmit the identifier of the aerosol generation device case to the aerosol generation device; and
determine verification has failed in response to a signal received from the aerosol generation device.

38. A system comprising:
an aerosol generation device comprising:
a transmitting/receiving section;
a memory section; and
a control section, wherein the control section is configured to determine whether the aerosol generation device is connected to an aerosol generation device case for a first time,
wherein, in a case where the aerosol generation device is connected to the aerosol generation device case for a first time, the control section is configured to control the transmitting/receiving section and the memory section to pair with the aerosol generation device case by:
transmitting, to the aerosol generation device case, an identifier of the aerosol generation device;
receiving, from the aerosol generation device case, an identifier of the aerosol generation device case;
storing the received identifier in the memory section of the aerosol generation device; and
establishing a wireless communication link with the paired aerosol generation device case, and
wherein, in a case where the aerosol generation device is not connected to the aerosol generation device case for a first time, the control section is configured to control the transmitting/receiving section and the memory section to pair with the aerosol generation device case by:
receiving, from the aerosol generation device case, the identifier of the aerosol generation device case;
determining whether the received identifier matches a first identifier stored in the memory section; and
determining verification has failed in a case where the received identifier does not match the first identifier stored in the memory section; and
the aerosol generation device case according to claim 28.
